(19) United States
(12) Patent Application Publication
(10) Pub. No.: US 2024/0386549 A1
(43) Pub. Date: Nov. 21, 2024

(54) IMAGE PROCESSING APPARATUS, AND IMAGE PROCESSING METHOD

(71) Applicants: CANON KABUSHIKI KAISHA, Tokyo (JP); CANON MEDICAL SYSTEMS CORPORATION, Tochigi (JP)

(72) Inventor: Naoki MATSUKI, Tokyo (JP)

(21) Appl. No.: 18/657,843

(22) Filed: May 8, 2024

(30) Foreign Application Priority Data
May 15, 2023 (JP) 2023-079923

(51) Int. Cl. G06T 7/00

(52) U.S. Cl. CPC G06T 7/0012; G06T 2207/30004

(57) ABSTRACT

Provided is an image processing apparatus which reduces time and effort required for a user to perform image adjustment at the time of observing an imaging finding, the image processing apparatus including: a finding acquiring unit configured to acquire, for a medical image being a diagnosis target, a plurality of imaging findings as a first imaging finding group; a finding selecting unit configured to select at least one imaging finding from the plurality of imaging findings; a determining unit configured to determine, for the selected at least one imaging finding, an image processing condition suitable for observation of an imaging finding; and an image acquiring unit configured to acquire a display image satisfying the determined image processing condition.

### BACKGROUND OF THE INVENTION

### Field of the Invention

The disclosure of the present specification relates to an image processing apparatus, and an image processing method.

### Description of the Related Art

In the medical field, there has been performed “image diagnosis” of performing diagnosis based on a medical image obtained by an imaging apparatus such as an X-ray computer tomography (CT) apparatus and a magnetic resonance imaging (MRI) apparatus. Work of observing the medical image to come to a diagnosis is referred to as “radiogram interpretation.” In the image diagnosis, for example, in response to a request from a primary doctor, a radiogram interpretation doctor who is a doctor specialized in the image diagnosis performs radiogram interpretation. The radiogram interpretation doctor identifies a lesion rendered in the medical image or a symptom of a patient who is a subject through comprehensive determination from imaging findings and various measurement values. The imaging findings represent characteristics of an image that may become a part of a basis of the diagnosis. In addition, the radiogram interpretation doctor writes, into a radiogram interpretation report, the process of reaching the diagnosis by using the image findings and the measurement values, and replies to the primary doctor being a requester.

Recently, various types of medical information are utilized for diagnosis, and expectations are rising for systems for analyzing a medical image or other medical information by a computer to allow a user such as a doctor to utilize the obtained results as a support for performing diagnosis. In Japanese Patent Application Laid-Open No. 2016-214323, there is disclosed a method of presenting, in a system of inferring an imaging finding and a diagnosis name from a pulmonary nodule image, position information of a region indicating this imaging finding in the pulmonary nodule image in order for the user to easily recognize the position of the imaging finding that becomes a basis of the inferred diagnosis name.

In order for the user such as a doctor to recognize the imaging finding, the user is required not only to know its position but also to observe the characteristics of the image. However, in the method as disclosed in Japanese Patent Application Laid-Open No. 2016-214323, in some cases, a display condition of the image is not suitable for observation of the characteristics of the image. In such cases, the user is required to observe the imaging finding while performing image adjustment.

### SUMMARY OF THE INVENTION

The present disclosure has been made in view of the above-mentioned circumstance, and has an object to reduce time and effort required for a user to perform image adjustment at the time of observing an imaging finding.

In order to solve the above-mentioned problem, according to one aspect of the present disclosure, there is provided an image processing apparatus including: a finding acquiring unit configured to acquire, for a medical image being a diagnosis target, a plurality of imaging findings as a first imaging finding group; a finding selecting unit configured to select at least one imaging finding from the plurality of imaging findings; a determining unit configured to determine, for the selected at least one imaging finding, an image processing condition suitable for observation of an imaging finding; and an image acquiring unit configured to acquire a display image satisfying the determined image processing condition.

According to the one aspect of the present disclosure, time and effort required for the user to perform the image adjustment at the time of observing the imaging finding can be reduced.

Further features of the present invention will become apparent from the following description of exemplary embodiments with reference to the attached drawings.

### BRIEF DESCRIPTION OF THE DRAWINGS

FIG. 1 is an example of a hardware configuration of an image processing apparatus according to a first embodiment of the present disclosure.

FIG. 2 is an example of a functional configuration of the image processing apparatus according to the first embodiment.

FIG. 3 is a flow chart for illustrating an example of processing to be performed by the image processing apparatus according to the first embodiment.

FIG. 4 is an example of input information to be generated in the image processing apparatus according to the first embodiment.

FIG. 5 is an example of a correspondence table between a finding and priority to be referred to by the image processing apparatus according to the first embodiment.

FIG. 6A is an example of a correspondence table between a finding and a display condition to be referred to by the image processing apparatus according to the first embodiment.

FIG. 6B is an example of a correspondence table between a finding and a display condition to be referred to by an image processing apparatus according to a modification example of the first embodiment.

FIG. 7A is an example of a display method to be performed by the image processing apparatus according to the first embodiment.

FIG. 7B is an example of the display method to be performed by the image processing apparatus according to the first embodiment.

FIG. 7C is an example of the display method to be performed by the image processing apparatus according to the first embodiment.

FIG. 7D is an example of the display method to be performed by the image processing apparatus according to the first embodiment.

FIG. 7E is an example of the display method to be performed by the image processing apparatus according to the first embodiment.

FIG. 7F is an example of the display method to be performed by the image processing apparatus according to the first embodiment.

FIG. 8 is an example of the display method to be performed by the image processing apparatus according to the first embodiment.

FIG. 9 is an example of a functional configuration of an image processing apparatus according to a second embodiment.

FIG. 10 is a flow chart for illustrating an example of processing to be performed by the image processing apparatus according to the second embodiment.

FIG. 11 is an example of a display method to be performed by an image processing apparatus according to a third embodiment.

FIG. 12 is an example of a functional configuration of the image processing apparatus according to the third embodiment.

FIG. 13 is an example of a report storing method in the third embodiment.

FIG. 14 is a flow chart for illustrating an example of processing to be performed by the image processing apparatus according to the third embodiment.

### DESCRIPTION OF THE EMBODIMENTS

Embodiments of an image processing device, an image processing method, and a program according to the present disclosure are described below with reference to the drawings. The embodiments described below do not limit the present disclosure set forth in the appended claims. The configurations of the embodiments described below are only examples, and the present disclosure is not limited to the illustrated configurations. A plurality of features are described in the embodiments, but the present disclosure does not necessarily require all of those plurality of features, and a plurality of features may be combined as appropriate. Further, in the attached drawings, the same or similar components are denoted by the same reference symbols, and redundant description thereof is omitted.

### First Embodiment

An image processing apparatus according to a first embodiment is now described. In the first embodiment, in a process of work of performing radiogram interpretation by a radiogram interpretation doctor, an image optimum for observation of an imaging finding is automatically determined and displayed. In the following, the image processing apparatus according to the first embodiment is described in the order of an example of a hardware configuration, an example of a functional configuration, and an example of a processing flow.

### (Hardware Configuration)

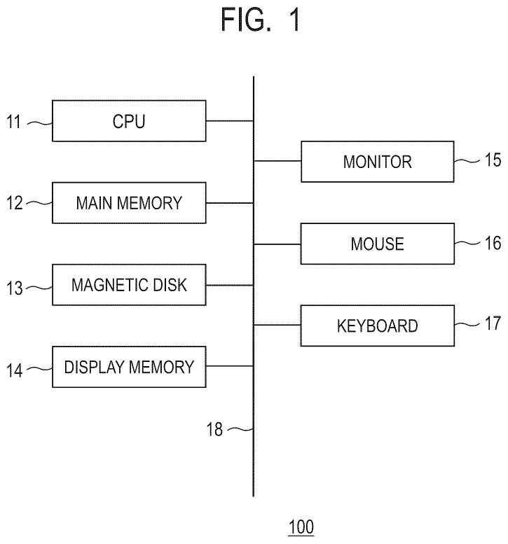

FIG. 1 is a diagram for illustrating an example of a hardware configuration of an image processing apparatus 100 according to the first embodiment. The image processing apparatus according to the first embodiment includes, for example, a central processing unit (CPU) 11, a main memory 12, a magnetic disk 13, a display memory 14, a monitor 15, a mouse 16, and a keyboard 17. Further, those components are connected to each other via a common bus 18 so that communication is allowed therebetween.

The CPU 11 mainly controls the operation of each component. The main memory 12 stores, for example, a control program to be executed by the CPU 11, and provides a work area used when the CPU 11 executes a program. The magnetic disk 13 stores programs for implementing various types of application software including, for example, an operating system (OS), device drivers for peripheral devices, and a program for performing processing to be described later or the like. The CPU 11 executes the program stored in the main memory 12 or the magnetic disk 13 to implement functions (software) of the image processing apparatus according to the first embodiment.

The display memory 14 temporarily stores, for example, display data to be displayed on the monitor 15. The monitor 15 is, for example, a cathode ray tube (CRT) monitor or a liquid crystal monitor, and displays an image, text, or the like based on the data from the display memory 14. The user performs pointing input and input of characters and the like by using the mouse 16 and the keyboard 17.

The configuration of the image processing apparatus 100 is not limited to the above-mentioned configuration. For example, the image processing apparatus 100 may include a plurality of processors. Further, the image processing apparatus 100 may include a graphic processing unit (GPU) or a field-programmable gate array (FPGA) in which part of processing is programmed.

### (Functional Configuration)

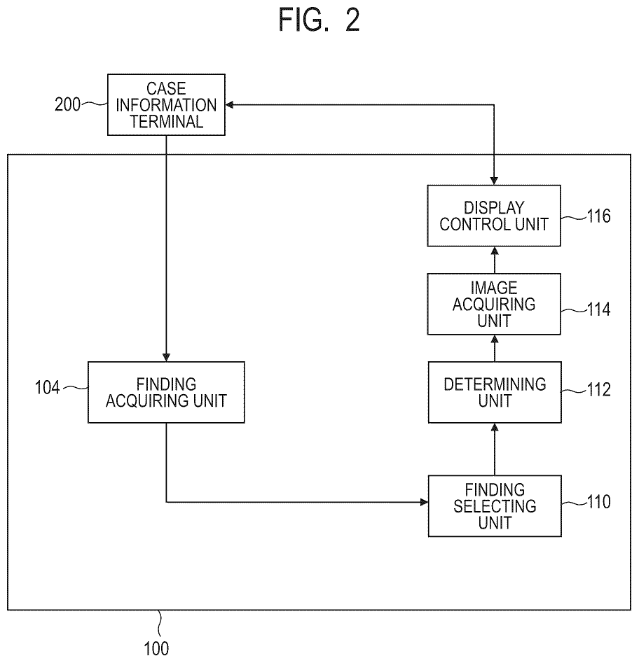

FIG. 2 is a diagram for illustrating an example of a functional configuration of the image processing apparatus for supporting diagnosis in the first embodiment. The image processing apparatus 100 is connected to a case information terminal 200 so that communication is allowed therebetween. The image processing apparatus 100 includes a finding acquiring unit 104, a finding selecting unit 110, a determining unit 112, an image acquiring unit 114, and a display control unit 116. The functional components of the image processing apparatus 100 are connected to each other by an internal bus or the like.

The case information terminal 200 acquires information on a case being a diagnosis target from a server (not shown). The information on a case refers to, for example, medical information such as a medical image and clinical information written on an electronic medical chart. The case information terminal 200 may be connected to external storage apparatus (not shown) such as a hard disk drive (HDD), a solid state drive (SSD), a CD drive, and a DVD drive, and may acquire the medical image from those external storage apparatus.

Further, the case information terminal 200 provides, via the display control unit 116, a graphical user interface (GUI) for allowing the user to select one of the acquired medical images. The selected medical image is displayed on the monitor 15 in an enlarged manner. The case information terminal 200 transmits the medical image selected by the user via this GUI to the image processing apparatus 100 via a network or the like.

The finding acquiring unit 104 acquires, based on the medical image serving as a target of radiogram interpretation (hereinafter referred to as “target image”), which has been transmitted from the case information terminal 200 to the image processing apparatus 100, an imaging finding regarding this target image. First, the finding acquiring unit 104 performs image processing on the target image to acquire an image feature amount of this target image. Next, the finding acquiring unit 104 infers the imaging finding regarding this target image based on the acquired image feature amount, and outputs the inferred imaging finding. The imaging finding is inferred by constructing, by deep learning or the like in advance, an inference machine for inferring the imaging finding based on the image feature amount and using the inference machine. The configuration of the finding acquiring unit 104 is not limited thereto, and may be a configuration in which the imaging finding regarding this target image is acquired from an external server (not shown) providing a similar function. The finding acquiring unit 104 may acquire an imaging finding input or selected by the user, or may acquire an imaging finding transmitted from another image processing apparatus. The present disclosure is not limited to acquisition through inference performed by the image processing apparatus 100.

The finding selecting unit 110 selects, from among the imaging findings output by the finding acquiring unit 104, an imaging finding serving as a target of display (hereinafter referred to as “selected imaging finding”), and outputs information on this selected imaging finding. The determining unit 112 determines a display condition of the target image based on the selected imaging finding output by the finding selecting unit 110, and outputs information on this display condition. The image acquiring unit 114 acquires or generates a display image regarding the target image (hereinafter referred to as “display image”) based on the display condition output by the determining unit 112, and causes the monitor 15 to display the display image via the display control unit 116. The display control unit 116 causes the monitor 15 to display the display image generated by the image acquiring unit 114 or the GUI to be operated by the user.

### (Processing Flow)

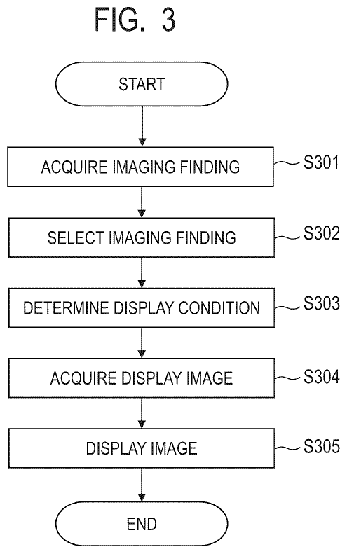

Next, with reference to FIG. 3, which is a flow chart for illustrating an example of processing to be performed by the above-mentioned image processing apparatus 100, the processing flow is described. In the first embodiment, the CPU 11 executes a program stored in the main memory 12 to implement the functions of the respective units, to thereby implement the processing (image processing method) illustrated in FIG. 3.

In the following description, the image feature amount regarding the target image is represented by Iₘ (m=1 to M), and an item of the imaging finding (finding item) is represented by Fₙ (n=1 to N). Symbol M represents the number of items of the image feature amount, and symbol N represents the number of items of the imaging finding. In this case, each of the items of Iₘ and Fₙ has a value. The items of Iₘ take continuous values, and Fₙ takes a continuous value or a discrete value (category value) depending on the item. When Fₙ takes a discrete value, each discrete value is represented by “f_{n k}.” That is, information for identifying an element among k elements (categories) corresponds to the value of this finding item. Symbol “k” takes various values depending on each Fₙ. Further, when the image feature amount Iₘ and the imaging finding Fₙ take continuous values, those values are represented by “iₘ” and “fₙ,” respectively.

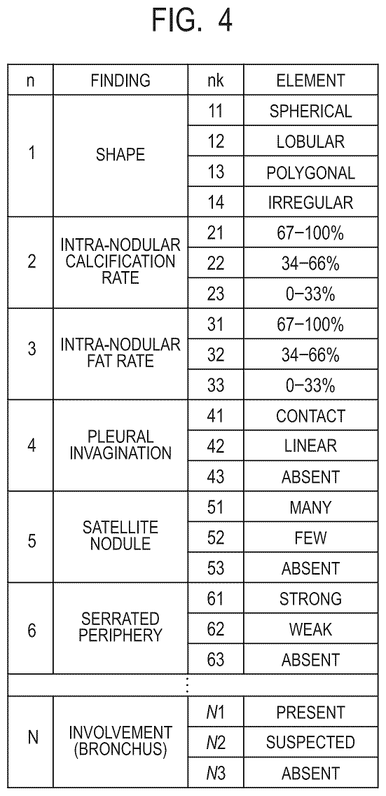

In the first embodiment, as an example, a case in which an image of a nodule-like shadow in a chest CT image is regarded as a target image is described. At this time, items (finding items) and values (values of findings) exemplified in FIG. 4 are treated as the imaging findings. For example, in the case of “shape” of a finding item F₁, its element is any one of four values of f_{1 1} being “spherical,” f_{1 2} being “lobular,” f_{1 3} being “polygonal,” and f_{1 4} being “irregular.” In the case of “intra-nodular calcification rate” of a finding item F₂, its element is any one of three values of f_{2 1} being “67% to 100%,” f_{2 2} being “34% to 66%,” and f_{2 3} being “0% to 33%.” In the first embodiment, all of the elements of the imaging findings are discrete values.

When the actual processing flow is started, in Step S301, the finding acquiring unit 104 first performs image processing based on a target image, to thereby acquire the image feature amount of this target image. The image feature amount acquired here may be a general image feature amount such as a mean value or variance of a density (luminance) within a processing target region of the image, or may be an image feature amount that is based on filter output.

Next, the finding acquiring unit 104 converts this image feature amount into an imaging finding group with a likelihood. For example, the imaging finding “shape” is inferred based on the image feature amount {i₁, i₂, . . . , i_{M} }. More specifically, which of f_{1 1}, f_{1 2}, f_{1 3}, and f_{1 4} the value of the finding item F₁ “shape” has is inferred by obtaining a likelihood of each element f_{1 k}. In this case, when the likelihood of f_{1 k} is represented by L(f_{1 k}), L(f_{1 1})+L(f_{1 2})+L(f_{1 3})+L(f_{1 4})=1.0 is satisfied. As the inference of the imaging finding, various methods that can output a value with a likelihood can be utilized. In the first embodiment, a multivalued neural network is used. The method of inferring the imaging finding described here is merely an example, and any publicly-known method may be used as the method of inferring the imaging finding from the image.

In Step S302, the finding selecting unit 110 selects at least one imaging finding from a plurality of imaging findings (items and values thereof) inferred in Step S301, and acquires the imaging finding as the selected imaging finding. Now, details of the acquisition of the selected imaging finding are described.

When selecting the imaging finding, first, the finding selecting unit 110 sets, for each imaging finding item, an element (identification information indicating the element) having the highest likelihood among elements of the imaging finding item as the value of this imaging finding. For example, when the likelihoods of the elements (f_{1 1}, f_{1 2}, f_{1 3}, f_{1 4}) of the imaging finding item “shape” are L(f_{1 1})=0.1, L(f_{1 2})=0.2, L(f_{1 3})=0.7, and L(f_{1 4})=0.0, the value of the imaging finding item F₁ “shape” is f_{1 3} (polygonal).

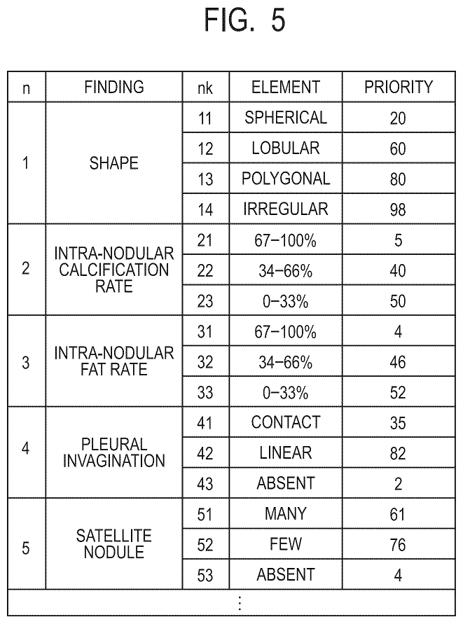

Next, the finding selecting unit 110 derives a priority of each imaging finding (item and value thereof) inferred in Step S301 based on a database (exemplified in FIG. 5) having stored therein the priority corresponding to the imaging finding (item and value thereof). FIG. 5 is medical information stored in, for example, the main memory 12, and is an example of a database indicating a relationship between the imaging finding and the priority accompanied thereby, which is determined in advance. In the first embodiment, the priority is set depending on the difficulty of finding the imaging finding. For example, in the intra-nodular calcification rate, it is difficult to find intra-nodular calcification having a smaller rate than intra-nodular calcification having a larger rate, and hence the intra-nodular calcification having a smaller rate is set to have a higher priority. The priority may be set based on other references, and may be set based on, for example, an influence degree on the final diagnosis. That is, for each imaging finding (combination of item and value), the priority may be set to become higher as the influence degree on the diagnosis becomes higher. Further, the priority may be set for each imaging finding item.

Next, the finding selecting unit 110 selects one imaging finding in accordance with the priority from the imaging findings inferred in Step S301, and acquires the imaging finding as the selected imaging finding. In the first embodiment, the imaging finding having the highest priority is selected. The method of selecting the imaging finding is not limited thereto, and, for example, an imaging finding having the second highest priority may be selected. Further, for example, when there are a plurality of imaging findings having a small difference in priority from the imaging finding having the highest priority (for example, the difference in priority falls below 5), a GUI for displaying the plurality of imaging findings may be prepared to allow the user to select the imaging finding. As another example, the finding selecting unit 110 may select a predetermined number of imaging findings in accordance with the priority.

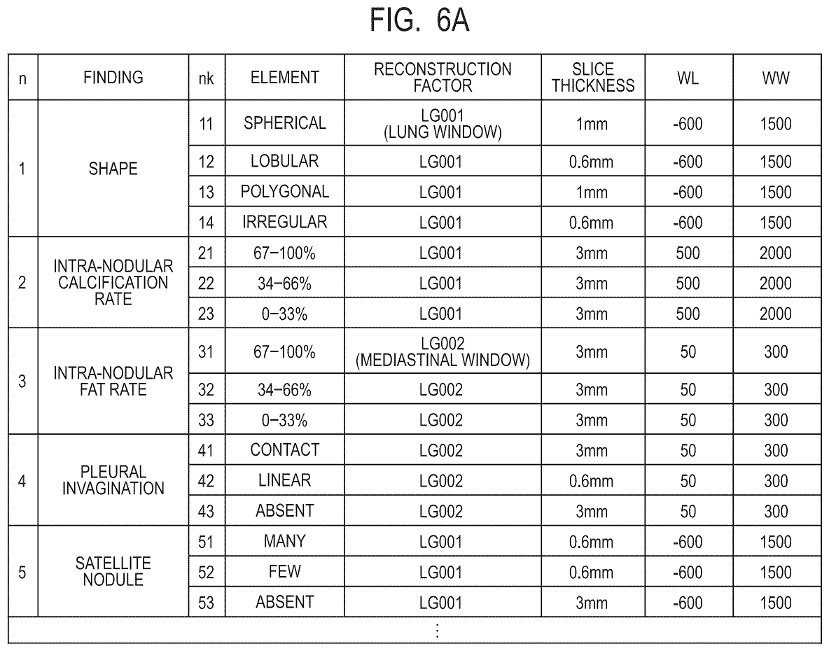

After the imaging finding is selected in Step S302, in Step S303, the determining unit 112 determines the display condition. Specifically, the determining unit 112 acquires, based on a database (exemplified in FIG. 6A) having stored therein an optimum display condition stored in association with the imaging finding (item and value thereof) in advance, the display condition corresponding to the selected imaging finding (item and value thereof) acquired in Step S302. Then, the determining unit 112 determines the acquired display condition as an image processing condition used when the display image is obtained. FIG. 6A is medical information stored in, for example, the main memory, and is an example of a database indicating the relationship between the imaging finding and the display condition accompanied thereby, which is determined in advance. In the first embodiment, as an example of the display condition, a reconstruction factor used when a signal obtained by the X-ray CT apparatus is reconstructed, a slice thickness, a window level (WL), and a window width (WW) are used.

After the display condition is determined, in Step S304, the image acquiring unit 114 first acquires an image corresponding to the display condition acquired in Step S303 as the display image. In the first embodiment, the image acquiring unit 114 subjects the target image to image processing based on the display condition acquired in Step S303, and acquires the processed image as the display image. For example, the target image is adjusted based on the values of WL and WW which are display conditions relating to the contrast of the image so that WL−WW/2 becomes the minimum value of the values of the image and WL+WW/2 becomes the maximum value of the values of the image. Then, the adjusted image is acquired as the display image.

The image acquiring unit 114 may be configured to acquire the image corresponding to the display condition acquired in Step S303 from a server (not shown) or the like. For example, the image acquiring unit 114 may acquire an image having a match in display conditions such as the reconstruction factor and the slice thickness from a server (not shown). At this time, when the server has no corresponding image, signal data before reconstruction may be acquired from an imaging apparatus, and the signal data may be reconstructed and then acquired.

Further, the image acquiring unit 114 may acquire an image having a match in part of the display condition acquired in Step S303 from a server (not shown) or the like, and may subject the target image to additional processing to acquire the processed image as the display image. For example, when the display condition includes the reconstruction factor, the slice thickness, WL, and WW, an image having a match in only the reconstruction factor and the slice thickness may be acquired from a server (not shown), and an image obtained by subjecting the acquired image to adjustment based on the values of WL and WW may be acquired as the display image. Further, the image acquiring unit 114 may acquire the target image as the display image when the display condition acquired in Step S303 and the display condition of the target image are the same.

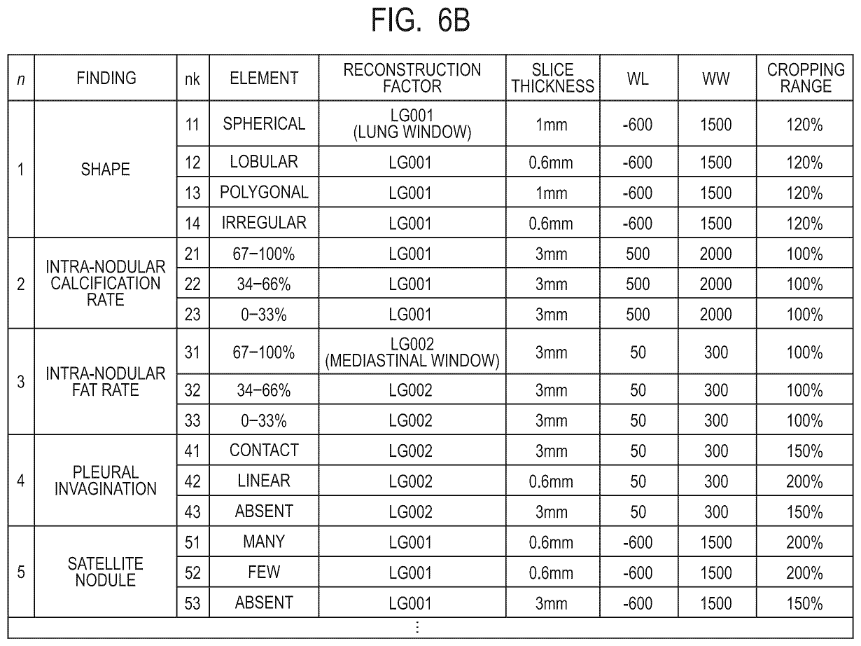

In Step S305, the display control unit 116 causes the monitor 15 to display the display image acquired in Step S304 as illustrated in FIG. 7B. At this time, as illustrated in FIG. 7C, the display image and the target image before subjecting the image to image processing based on the display condition may be arranged side by side so that the images are displayed in a comparable manner. FIG. 7A to FIG. 7F are examples of an image after image processing, which is displayed on the monitor 15 in the first embodiment and modification examples of the first embodiment to be described later. FIG. 7A is a display example of the target image before the above-mentioned image processing is performed, FIG. 7B is a display example of an image after the image processing in the first embodiment, and FIG. 7C is a display example in which the image before processing and the image after processing are displayed side by side.

As described above, the image processing apparatus according to the present disclosure includes the finding acquiring unit 104, the finding selecting unit 110, the determining unit 112, and the image acquiring unit 114. The finding acquiring unit 104 functions as a finding acquiring unit in the present disclosure, and executes, for example, as described in Step S301, processing of acquiring, for a medical image being a diagnosis target, a plurality of imaging findings as a first imaging finding group. In the first embodiment, the finding acquiring unit 104 acquires the imaging finding through inference performed on the medical image. The finding selecting unit 110 functions as a finding selecting unit in the present disclosure, and executes, for example, as described in Step S302, processing of selecting at least one imaging finding from the plurality of imaging findings inferred in Step S301. The determining unit 112 functions as a determining unit in the present disclosure, and executes, for example, as described in Step S303, processing of determining, for the imaging finding selected in Step S302, an image processing condition suitable for observation of the imaging finding. The image acquiring unit 114 functions as an image acquiring unit in the present disclosure, and executes, for example, as described in Step S304, processing of acquiring a display image satisfying the image processing condition determined in Step S303.

In the above-mentioned image processing apparatus, the determining unit 112 can determine the image processing condition based on the item of the selected imaging finding and the value of the selected imaging finding by utilizing, for example, the database exemplified in FIG. 6A. Further, the image acquiring unit 114 can acquire, as the display image, a medical image being a diagnosis target subjected to image processing based on the image processing condition determined by the determining unit 112. As described with reference to Step S304, the display image may be acquired by acquiring an image having a match in condition from a server, or by applying the image processing condition determined by the image acquiring unit 114 functioning as an image processing unit to the medical image being the diagnosis target. Further, as the image processing to which the image is subjected, at least one of a luminance level changing processing, gradation converting processing, resolution converting processing, or cropping processing can be executed. Moreover, the image acquiring unit 114 may acquire the display image based on the determined image processing condition from a plurality of images subjected to different types of image processing.

Further, the image processing apparatus according to the present disclosure may include the display control unit 116 for causing a display unit exemplified by the monitor 15 to display the medical image being the diagnosis target. The display control unit 116 functions as a display control unit in the present disclosure. The display control unit 116 can cause the monitor 15 to display the display image so as to be comparable to the medical image being the diagnosis target as exemplified in, for example, FIG. 7C, when the image processing condition applied to the display of the medical image being the diagnosis target is different from the image processing condition determined by the determining unit 112.

Through execution of the processing described above, the image processing condition for observing the finding can be automatically determined, and an image satisfying this image processing condition can be automatically displayed. In this manner, time and effort required for the user to perform image adjustment can be reduced.

The target image exemplified in the first embodiment described above is merely an example, and the target image that becomes the diagnosis target to which the present disclosure is directed is not limited to the target image exemplified here. As a diagnosis target site to which the present disclosure is applicable, in addition to the chest, for example, the abdomen, the head, or the breast is conceivable. Further, the lesion is also not limited to the exemplified nodule-like shadow. For example, all “abnormal shadows” including a ground glass opacity, a granular shadow, and an infiltrative shadow may be targets. Moreover, an embodiment in which an X-ray CT apparatus is used as a modality for obtaining the image is exemplified here. However, an ultrasonic diagnosis apparatus, an MRI apparatus, or the like may be used as a different mode, and a tumor shadow of breast ultrasound, a tumor shadow of an abdominal CT image, or the like is exemplified as an image obtained from another modality.

### Modification Example 1 of First Embodiment

In Step S302, the finding selecting unit 110 may acquire the selected imaging finding based on the likelihood of the imaging finding. First, the finding selecting unit 110 sets, for each imaging finding, the highest likelihood among the likelihoods of the elements of the imaging finding as the likelihood of this imaging finding. For example, when the likelihoods of the elements (f_{1 1}, f_{1 2}, f_{1 3}, f_{1 4}) of the imaging finding “shape” are L(f_{1 1})=0.1, L(f_{1 2})=0.2, L(f_{1 3})=0.7, and (f_{1 4})=0.0, the likelihood of the finding item F₁ “shape” is 0.7. Similarly, the likelihoods of all of the imaging findings are obtained, and the imaging finding selected based on the likelihood is acquired as the selected imaging finding. For example, when the imaging finding having the lowest likelihood is selected, the imaging finding that is required to be checked by the doctor can be acquired as the selected imaging finding.

The method of selecting the imaging finding is not limited thereto, and, for example, the imaging finding having the highest likelihood may be selected. Further, for example, the likelihood and the priority may be used together so that, when there are a plurality of imaging findings having a small difference in priority from the imaging finding having the highest priority (for example, when the difference in priority falls below 5), the imaging finding having the lowest likelihood may be selected from those plurality of imaging findings.

That is, as described in Modification Example 1, there can also be employed a mode in which the finding selecting unit 110 selects the imaging finding based on the likelihood of the imaging finding inferred by the finding acquiring unit (finding acquiring unit 104). As described in the description of Step S301 in the first embodiment, the likelihood can be obtained by the finding acquiring unit 104 converting the image feature amount of the medical image being the diagnosis target into an imaging finding group (first imaging finding group) with a likelihood.

Further, the likelihood of the imaging finding may be normalized such that a case in which the likelihoods of the respective elements become the same value has the minimum value. For example, when the likelihoods of the elements (f_{1 1}, f_{1 2}, f_{1 3}, f_{1 4}) of the imaging finding “shape” are L(f_{1 1})=0.25, L(f_{1 2})=0.25, L(f_{1 3})=0.25, and L(f_{1 4})=0.25, all of the elements have the same likelihood, and hence the value cannot be identified to one. Through use of the likelihood at this time as the minimum value, when the above-mentioned likelihood of 0.7 of the finding item F₁ “shape” is normalized such that the minimum value becomes 0, the likelihood of the finding item F₁ “shape” becomes (0.7−0.25)/(1.0−0.25). When the likelihood is normalized in this manner, the likelihoods of the imaging findings having different numbers of elements can be compared to each other.

### Modification Example 2 of First Embodiment

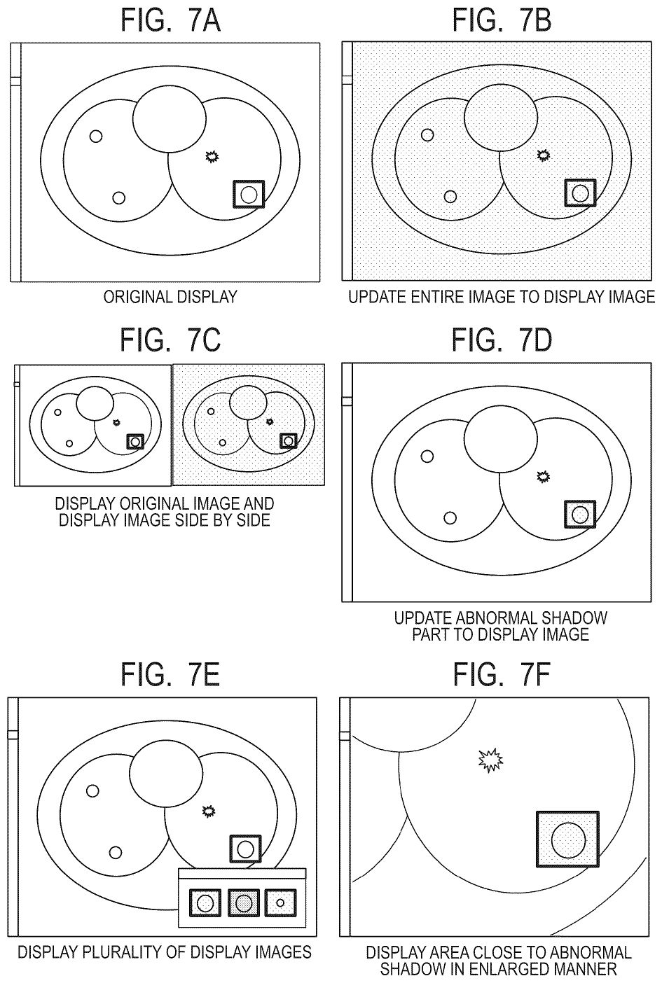

In Step S302, the finding selecting unit 110 may acquire two or more selected imaging findings. In this case, for example, a plurality of imaging findings can be selected in descending order of priority corresponding to the imaging finding and the value thereof. Further, in this case, through Step S303 and Step S304 subsequent thereto, a plurality of display images are acquired. A display example of a case in which a plurality of display images are acquired in this manner is illustrated in FIG. 8. The display screen exemplified in FIG. 8 displays a plurality of images as thumbnails, and an image selected through use of a cursor indicated by the arrow is displayed in an enlarged manner. That is, when a plurality of imaging findings are selected and image processing conditions are determined for the plurality of imaging findings, respectively, the display control unit 116 can cause the monitor 15 to display, together with the medical image being the diagnosis target, display images satisfying the plurality of image processing conditions, respectively, in a switchable manner. When a GUI as illustrated in FIG. 8 is provided so that an image to be displayed can be switched through user's designation, a plurality of imaging findings that are required to be checked can be easily switched.

### Modification Example 3 of First Embodiment

In Step S303, the display condition acquired by the determining unit 112 may be applied not to the entire image but to an abnormal shadow part in the image. In this case, the abnormal shadow refers to a part that is suspected to be a lesion in the image, such as a nodular shadow of a lung. The region of the abnormal shadow in the target image may be acquired through an operation of the user, or may be automatically acquired through use of a model trained in advance by a multivalued neural network or the like. In this case, the case information terminal 200 provides a GUI for surrounding the abnormal shadow in the image by a rectangular shape so that the abnormal shadow region is acquired through the operation of the user.

At this time, in Step S301, the finding acquiring unit 104 infers the imaging finding through use of only the abnormal shadow part in the target image. Further, in Step S305, as illustrated in FIG. 7D, the display control unit 116 may replace an image by an image after image processing only in the region of the abnormal shadow. Further, as illustrated in FIG. 7E, only the abnormal shadow region may be displayed in another window. FIG. 7E shows, in another window, a plurality of partial images of the abnormal shadow region obtained by subjecting the abnormal shadow region to different types of image processing. Further, as illustrated in FIG. 7F, an enlarged image including the abnormal shadow region may be displayed. In this manner, the user can concentrate on the observation of the abnormal shadow part.

The image processing apparatus according to the present disclosure may further include an identification unit (finding acquiring unit 104) for identifying the abnormal shadow. In Modification Example 3, the identification unit may use, as input, for example, an operation made by the user identifying the abnormal shadow, or may use a model trained in advance by a multivalued neural network or the like to automatically identify the abnormal shadow. When the abnormal shadow can be identified, the determining unit 112 can determine the image processing condition for the imaging finding relating to this abnormal shadow. Then, the image acquiring unit 114 can acquire an image satisfying the determined image processing condition and including the abnormal shadow as the display image.

Moreover, when the medical image being the diagnosis target is displayed, the display control unit 116 can generate a partial medical image including a region corresponding to the imaging finding from the display image to cause the monitor 15 to display the partial medical image. That is, the abnormal shadow is identified as the region corresponding to the imaging finding, and, for example, as illustrated in FIG. 7D, a display image obtained by updating only the part identified as the abnormal shadow to the partial medical image or a partial medical image obtained from this display image can be displayed on the monitor 15 together with the medical image being the diagnosis target. In more detail, in the example illustrated in FIG. 7D, the image processing condition applied to the display of the medical image being the diagnosis target is different from the image processing condition of the partial medical image determined by the determining unit 112. In such a case, the display control unit 116 can cause the monitor 15 to display a superimposition image obtained by superimposing the partial medical image onto this medical image being the diagnosis target. Moreover, as illustrated in FIG. 7E, the partial medical image may be displayed on the monitor 15 so as to be comparable to this medical image being the diagnosis target.

### Modification Example 4 of First Embodiment

In the above-mentioned embodiment or modification examples, WW, WL, and the reconstruction factor have been described as examples of the display conditions serving as targets adjusted when image processing is performed. However, the display conditions adjusted when the image processing is executed are not limited to those conditions, and other conditions may be used.

For example, as illustrated in FIG. 6B, in addition to the above-mentioned display conditions, a condition regarding a cropping range of the image may be added. The cropping range is designated by a rate in a case in which a rectangular region circumscribed to the abnormal shadow is regarded as 100%. The cropping range can be changed depending on the imaging finding. For example, the cropping range is set to be wide in a case of an imaging finding relating to a wide range around the abnormal shadow, such as a satellite nodule, and is set to be narrow in a case of an imaging finding relating to characteristics inside of the abnormal shadow, such as calcification and fat.

Further, for example, filter processing to be applied to the target image may be added as the display condition. The filter processing to be applied is different depending on the imaging finding (item and value thereof), similarly to other display conditions. For example, for an imaging finding in which a fine shape of the abnormal shadow is required to be checked, such as pleural invagination having a linear shadow, known filter processing such as filter processing for raising the sharpness may be applied. Further, for example, for an imaging finding in which a shape or an external shape of the abnormal shadow is required to be checked, such as pleural invagination, known filter processing such as binarization processing may be applied. The binarization processing is not applied to an imaging finding in which a density inside of the abnormal shadow is required to be checked, such as the intra-nodular calcification rate or an intra-nodular fat rate. In this manner, an image subjected to optimum image processing depending on the finding can be displayed.

### Second Embodiment

In the first embodiment, there has been described a case in which, in the process of the work of performing radiogram interpretation by the radiogram interpretation doctor, an image optimum for observation of the imaging finding is automatically determined and displayed. In contrast, as an image processing apparatus according to a second embodiment, there is described now a case in which, in a process of radiogram interpretation work of coming to a diagnosis by the radiogram interpretation doctor, an image optimum for observation of an imaging finding having a high influence degree on the diagnosis is automatically displayed. In the following, the image processing apparatus according to the second embodiment is described in the order of an example of a functional configuration and an example of a processing flow. The hardware configuration is similar to that of the first embodiment, and hence description thereof is omitted here.

### (Functional Configuration)

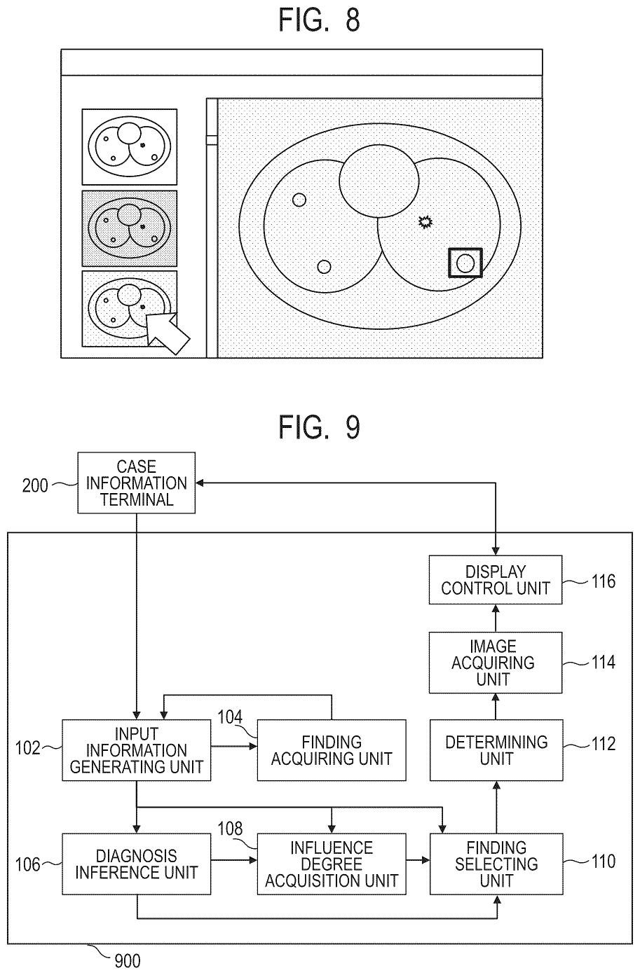

FIG. 9 is a diagram for illustrating an example of the functional configuration of the image processing apparatus according to the second embodiment. An image processing apparatus 900 according to the second embodiment further includes an input information generating unit 102, a diagnosis inference unit 106, and an influence degree acquiring unit 108 in addition to the functional configuration of the image processing apparatus 100 according to the first embodiment. Functions other than the functions described below are the same as those described in the description of the first embodiment, and hence description thereof is omitted here.

The input information generating unit 102 generates input information to be input to the diagnosis inference unit 106, based on the target image transmitted from the case information terminal 200 to the image processing apparatus 900. In the second embodiment, the input information generating unit 102 outputs the target image to the finding acquiring unit 104, and acquires the imaging finding output by the finding acquiring unit 104 as a result. In addition, the input information generating unit 102 outputs the acquired imaging finding as the input information to the diagnosis inference unit 106.

The finding acquiring unit 104 in the second embodiment infers the imaging finding based on the target image output from the input information generating unit 102, and outputs the inference result. The inference of the imaging finding is performed by a method similar to that of the first embodiment. The diagnosis inference unit 106 infers a diagnosis name based on the input information (imaging finding in the second embodiment) output from the input information generating unit 102, and outputs the inference result.

The influence degree acquiring unit 108 acquires an influence degree that each element included in the input information exerts on the inference result, through use of the input information output from the input information generating unit 102 and the inference result output from the diagnosis inference unit 106, and outputs information on this influence degree. The finding selecting unit 110 in the second embodiment acquires the selected imaging finding based on the input information output from the input information generating unit 102, the inference result output from the diagnosis inference unit 106, and the influence degree output from the influence degree acquiring unit 108, and outputs information on this selected imaging finding.

### (Processing Flow)

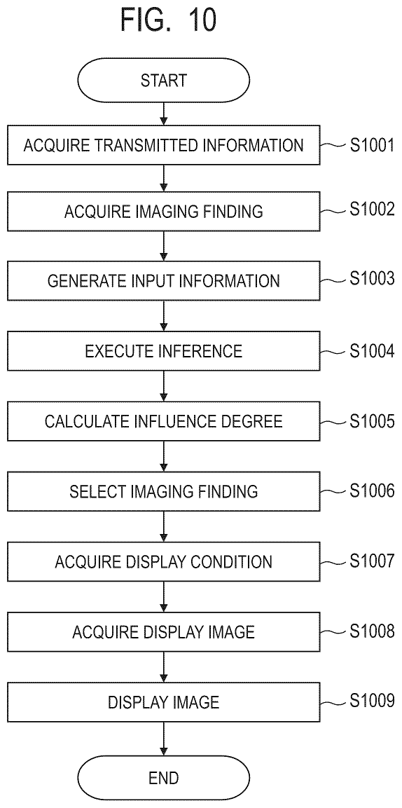

Next, with reference to FIG. 10, which is a flow chart for illustrating an example of processing to be performed by the above-mentioned image processing apparatus 900, the processing flow is described. The image feature amount Iₘ and the imaging finding Fₙ used in the following description are similar to those described in the first embodiment.

Further, in the following description, a set including the values of Iₘ and Fₙ as elements is represented by E, and input information thereof is represented by E_{f}. Moreover, in the following description, a diagnosis name is represented by D. Further, in the second embodiment, there is exemplified a case in which the diagnosis inference unit 106 infers, as the diagnosis name regarding the abnormal shadow of the lung, any one of the three values of primary lung cancer, lung metastasis of cancer, and others. In addition, the primary lung cancer, the lung metastasis of cancer, and the others are represented by d₁, d₂, and d₃, respectively, and the inference probability of a diagnosis name dᵤ (u=1, 2, 3) in a case in which the input information E_{f} is given as input to the diagnosis inference unit 106 is represented by P (dᵤ|E_{f}).

When the actual processing flow is started, in Step S1001, the input information generating unit 102 acquires the target image transmitted from the case information terminal 200 to the image processing apparatus 900.

In Step S1002 subsequent thereto, a processing step similar to Step S301 of FIG. 3 in the first embodiment is performed. That is, the finding acquiring unit 104 acquires an imaging finding with a likelihood from the target image output in Step S1001.

Next, in Step S1003, the input information generating unit 102 generates a set of imaging findings acquired in Step S1002 as the input information. At this time, the imaging finding is generated as the input information while maintaining the likelihood.

In Step S1004, the diagnosis inference unit 106 executes the inference regarding the abnormal shadow of the lung being the diagnosis target, based on the input information generated in Step S1003. That is, the diagnosis inference unit 106 performs inference through use of the information on the imaging finding acquired based on the image feature amount as the input information. In the second embodiment, the diagnosis inference unit 106 performs inference by utilizing a Bayesian network, but a method of inference is not limited thereto. For example, a support vector machine or a neural network may be used for inference.

In the second embodiment, the value of the imaging finding is indicated by a likelihood, and hence the inference is executed for all combinations of the imaging findings, and the inference results are integrated through use of the likelihood. An example of a case in which the imaging findings are Fₐ {f_{a 1}, f_{a 2}} and F_{b} {f_{b 1}, f_{b 2}} is described here. First, the diagnosis inference unit 106 generates pieces of tentative input information (E_{z}) that consider all combinations of the elements included in the input information. In the case of this example, the diagnosis inference unit 106 generates four pieces of tentative input information of E₁={f_{a 1}, f_{b 1}}, E₂={f_{a 1}, f_{b 2}}, E₃={f_{a 2}, f_{b 1}}, and E₄={f_{a 2}, f_{b 2}}. Then, the diagnosis inference unit 106 acquires P(dₛ|E_{z}) through use of each piece of tentative input information.

Moreover, the diagnosis inference unit 106 acquires a value obtained by multiplying each P(dₛ|E_{z}) by the likelihood of the imaging finding and adding results thereof as a final inference result. In the above-mentioned example, the diagnosis inference unit 106 acquires L(f_{a 1})×L(f_{b 1})×P(dₛ|E₁)+ . . . +L(f_{a 2})×L(f_{b 2})×P(dₛ|E₄) as the final inference result P(dₛ|E_{f}). In the above-mentioned example, the inference result can be expressed by Equation 1.

$$P ( {d}_{s} \vert {E}_{f} ) = {\sum }_{z = 1}^{Z} ⌊ \{ {\prod }_{{f}_{nk} ∈ {E}_{s}} L ( {f}_{nk} ) \} P ( {d}_{s} \vert {E}_{z} ) ⌋ \qquad Equation 1$$

That is, the diagnosis inference unit 106 generates a plurality of pieces of tentative input information each formed of at least part of information among pieces of information on the finding included in the input information, and infers the diagnosis name based on a result obtained by inference based on each of the plurality of pieces of tentative input information and a likelihood, that is, statistical information. In order to reduce an acquisition amount, the diagnosis inference unit 106 may be configured not to consider a value of an imaging finding having a likelihood equal to or lower than a threshold value.

Next, in Step S1005, the influence degree acquiring unit 108 acquires the influence degree that each element of the input information exerts on the inference result, through use of the input information generated in Step S1002 and the inference result of inference executed in Step S1004. That is, the influence degree acquiring unit 108 acquires the influence degree which is a degree of influence exerted on the inference of the diagnosis name, for each piece of information used as the input of inference by the diagnosis inference unit 106.

In the second embodiment, the influence degree on a diagnosis name “d_{f}” having the highest inference probability among the diagnosis names is acquired. Specifically, the influence degree of a certain element “eᵥ” (eᵥ∈E_{f}) is obtained by subtracting the inference probability of “d_{f}” in a case in which inference is performed with only “eᵥ” being removed from E_{f} from the inference probability of “d_{f}” in a case in which inference is performed through use of the input information E_{f}. The influence degree of the element is represented by I(eᵥ), and the influence degree is defined as Equation 2.

$$I ( {e}_{v} ) = P ( {d}_{f} \vert {E}_{f} ) - P ( {d}_{f} \vert {E}_{f} - {e}_{v} ) \qquad Equation 2$$

When I(eᵥ) is positive, this case represents that the inference probability of “d_{f}” has reduced because “eᵥ” is not included in the input information. Thus, “eᵥ” can be considered as information affirming “d_{f}”. Meanwhile, when I(eᵥ) is negative, this case represents that the inference probability of “d_{f}” has increased because “eᵥ” is not included in the input information. Thus, “eᵥ” can be considered as information denying “d_{f}”.

After the influence degree is obtained, in Step S1006, the finding selecting unit 110 acquires, as the selected imaging finding, an imaging finding having the highest influence degree acquired in Step S1005 among the imaging findings included in the input information acquired in Step S1002. In consideration of the negative influence degree on the inference result, an imaging finding having the highest absolute value of the influence degree may be acquired as the selected imaging finding.

In Step S1007, a processing step similar to Step S303 of FIG. 3 is performed. That is, the determining unit 112 acquires the display condition corresponding to the finding acquired in Step S1006.

In Step S1008, a processing step similar to Step S304 of FIG. 3 is performed. That is, the image acquiring unit 114 acquires an image corresponding to the display condition acquired in Step S1007 as the display image.

After the display image is acquired, in Step S1009, the display control unit 116 causes the monitor 15 to display the display image acquired in Step S1008.

As described above, the image processing apparatus according to the present disclosure may further include the influence degree acquiring unit 108 in addition to the configuration described in the first embodiment. The influence degree acquiring unit 108 functions as an influence degree acquiring unit in the present disclosure. In the case of such a configuration, the influence degree acquiring unit 108 acquires the influence degree on the diagnosis of the imaging finding inferred by the finding acquiring unit 104 or the input information generating unit 102. Further, at this time, the finding selecting unit 110 can select the imaging finding based on the acquired influence degree.

Further, the image processing apparatus according to the present disclosure may further include the diagnosis inference unit 106. The diagnosis inference unit 106 functions as a diagnosis inference unit in the present disclosure. In such a case, the diagnosis inference unit 106 can infer the diagnosis name through use of the imaging finding as input. Further, the above-mentioned influence degree acquiring unit 108 can acquire, as the influence degree on the diagnosis, the influence degree of the imaging finding on the diagnosis of the inferred diagnosis name.

Through execution of the processing described above, the image processing condition for observing the imaging finding that becomes a basis of the diagnosis can be automatically determined, and an image satisfying this image processing condition can be automatically displayed. In this manner, time and effort required for the user to perform image adjustment can be reduced.

### Modification Example 1 of Second Embodiment

In Step S1006 in the above-mentioned second embodiment, the finding selecting unit 110 selects the imaging finding having the highest influence degree. However, the target to be selected by the finding selecting unit 110 is not limited to the imaging finding having the highest influence degree. For example, a plurality of imaging findings may be selected in descending order of influence degree, and those imaging findings may be used as the selected imaging finding.

In Modification Example 1, a plurality of display images are acquired through Step S1007 and Step S1008 subsequent thereto. Accordingly, for example, a GUI illustrated in FIG. 8 may be provided so that the user can switch the image to be displayed. The method of displaying a plurality of images is not limited thereto. For example, as illustrated in FIG. 7C, the plurality of images may be displayed side by side, or, as illustrated in FIG. 7E, the plurality of images of only the region of the abnormal shadow may be displayed side by side. In this manner, a plurality of imaging findings that are required to be checked can be checked.

### Modification Example 2 of Second Embodiment

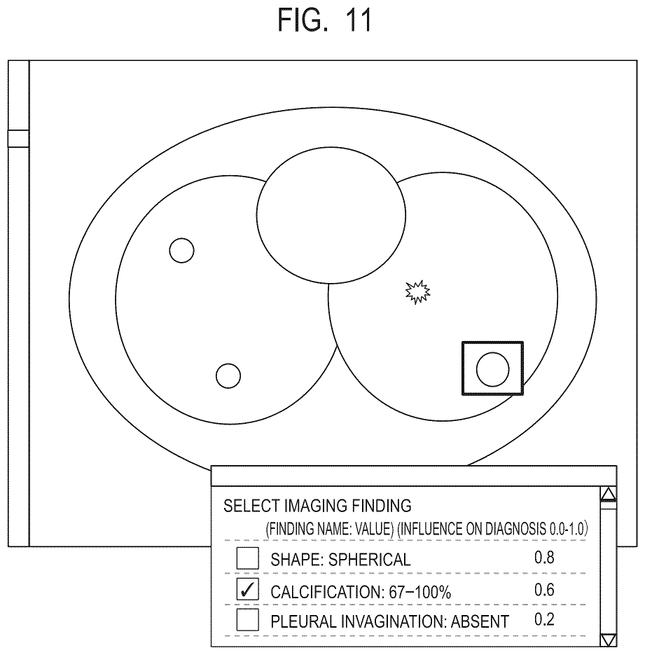

In the above-mentioned second embodiment and Modification Example 1 thereof, in Step S1006, the finding selecting unit 110 automatically acquires the selected imaging finding. However, a mode in which the finding selecting unit 110 does not select a finding can be employed. For example, information on the imaging finding included in the input information acquired in Step S1003 and information on the influence degree on the diagnosis of this imaging finding acquired in Step S1005 may be presented to the user to allow the user to manually select the imaging finding. An example of a selection screen displayed on the monitor 15 in this case is illustrated in FIG. 11. As exemplified in FIG. 11, a list of the imaging finding and its value is displayed, and the user can select the imaging finding through an operation of the case information terminal 200. In this manner, display suitable for checking the imaging finding that the doctor desires to check can be performed.

### Modification Example 3 of Second Embodiment

In the above-mentioned second embodiment, in Step S1006, the finding selecting unit 110 obtains the selected imaging finding based on the result of the diagnosis inference and the influence degree. However, the finding selecting unit 110 may acquire the selected imaging finding based only on the likelihood of the imaging finding, regardless of the result of diagnosis inference and the influence degree.

In this case, it is assumed that the likelihood of the imaging finding refers to the largest likelihood among the likelihoods of the respective elements of the imaging finding. For example, in the case of the finding item F₁ “shape” of the imaging finding illustrated in FIG. 4, the highest likelihood among the likelihoods L(f_{1 1}), L(f_{1 2}), L(f_{1 3}), and L(f_{1 4}) of the respective elements is regarded as the likelihood of the finding item F₁ of the imaging finding. In this case, the likelihoods of all of the findings are obtained, and then the imaging finding having the lowest likelihood is acquired as the selected imaging finding.

Further, the likelihood and the information on the influence degree on the diagnosis inference can be combined with each other. For example, an imaging finding having the lowest likelihood may be acquired as the selected imaging finding from an imaging finding group in which the influence degree on the diagnosis inference has a certain value or more. In this manner, display suitable for checking the imaging finding that has a low likelihood of inference and is required to be checked by the doctor can be performed.

### Third Embodiment

An image processing apparatus according to a third embodiment automatically displays, when the radiogram interpretation result is already present for the target image, an image optimum for observation of the imaging finding that is required to be checked. Examples of the case in which the radiogram interpretation result is already present include a case in which a past image and a radiogram interpretation result regarding this past image are present and a case in which radiogram interpretation results given by different doctors are present. In the following, the image processing apparatus according to the third embodiment is described in the order of an example of a functional configuration and an example of a processing flow. The hardware configuration is similar to that of the first embodiment, and hence description thereof is omitted here.

### (Functional Configuration)

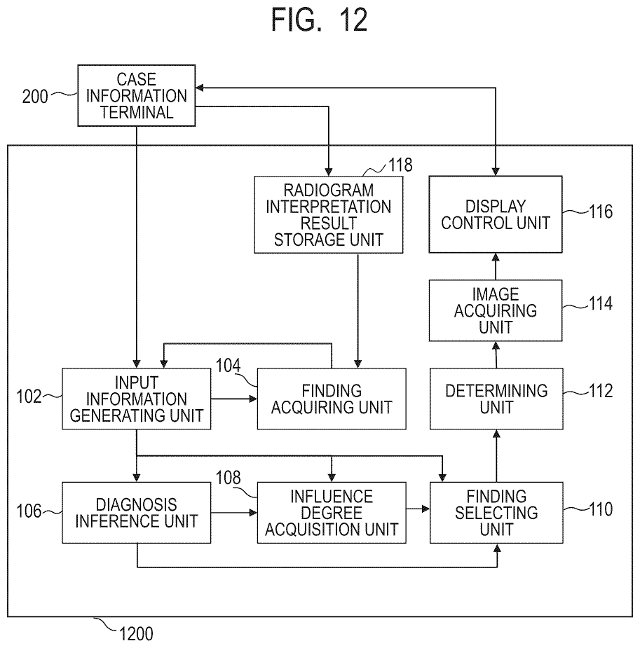

FIG. 12 is a diagram for illustrating an example of the functional configuration of the image processing apparatus according to the third embodiment. An image processing apparatus 1200 according to the third embodiment further includes a radiogram interpretation result storage unit 118 in addition to the functional configuration of the second embodiment. Functions other than the functions described below are the same as those described in the description of the first embodiment and the second embodiment, and hence description thereof is omitted here.

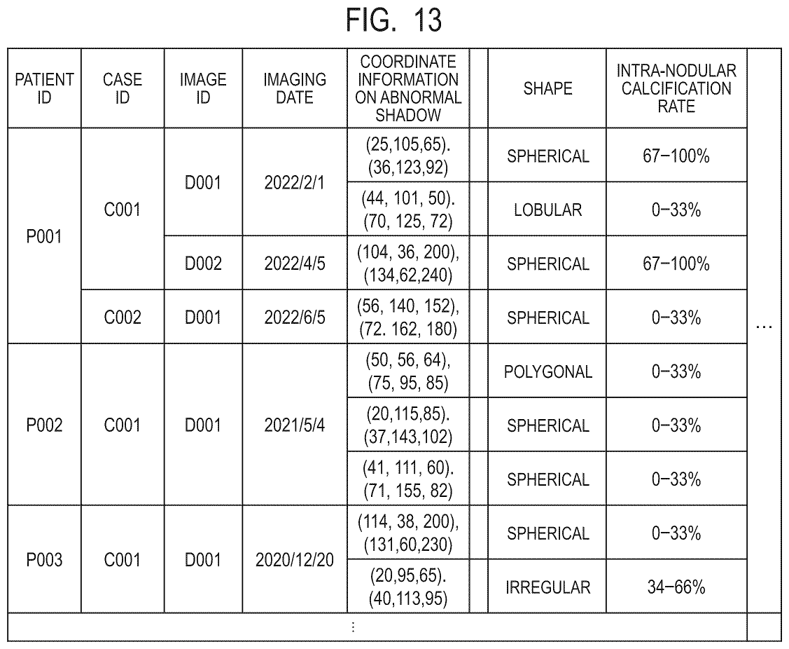

The radiogram interpretation result storage unit 118 associates, in response to the instruction given by the user via the case information terminal 200, information for identifying the image in the progress of radiogram interpretation with coordinate information and finding information on the abnormal shadow designated by the user, and stores the associated pieces of information as a radiogram interpretation result. The information for identifying the image in the progress of radiogram interpretation is, for example, a patient ID, a case ID, an image ID, and an imaging date (imaging period). Further, the coordinate information on the abnormal shadow is, for example, coordinates (pixel values in depth, vertical, and horizontal directions) of a start point and an end point of a cuboid surrounding the abnormal shadow, and the user manually inputs this coordinate information. Further, as the finding information, finding information generated by the finding acquiring unit 104 may be used, or the user may manually input the finding information. The radiogram interpretation result is stored in a server (not shown). FIG. 13 shows an example of the stored radiogram interpretation result.

### (Processing Flow)

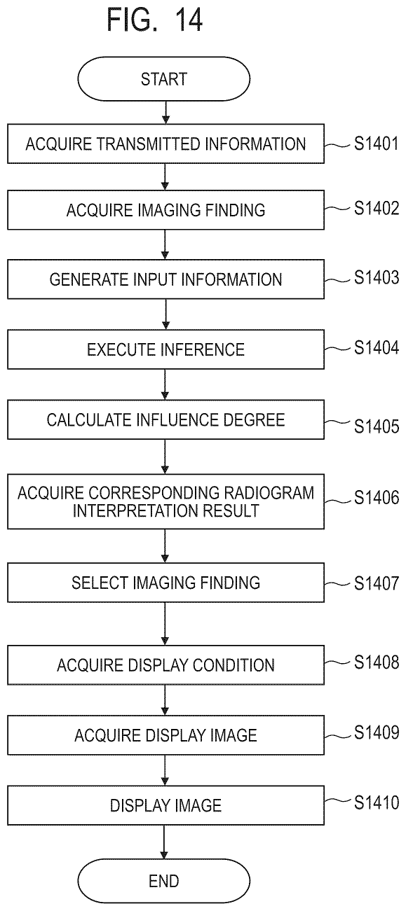

With reference to FIG. 14, which is a flow chart for illustrating an example of processing to be performed by the above-mentioned image processing apparatus 1200, the processing flow performed in the third embodiment is described. Some of processing steps overlap with those of the flow chart of FIG. 10 in the second embodiment, and hence processing steps performed in the overlapping steps are indicated by the overlapping steps, and description thereof is omitted here.

Processing steps performed from Step S1401 to Step S1405 are similar to the processing steps performed from Step S1001 to Step S1005 in the second embodiment.

In Step S1406, the finding acquiring unit 104 acquires the radiogram interpretation result corresponding to the target image from a server (not shown). In the third embodiment, the acquired radiogram interpretation result is a radiogram interpretation result having the same patient ID but a different imaging date (imaging period), that is, a past radiogram interpretation result of the same patient.

In Step S1407, the finding selecting unit 110 identifies the same abnormal shadow as the abnormal shadow designated by the user, from among all of the abnormal shadows included in the radiogram interpretation result acquired in Step S1406, and acquires information on the imaging finding regarding this abnormal shadow from the radiogram interpretation result. The abnormal shadow is identified by comparing pieces of coordinate information to each other. Before the pieces of coordinate information are compared to each other, registration or deformation processing of the image acquired from the radiogram interpretation result and the image in the progress of radiogram interpretation may be performed to correct the coordinate information.

Further, the finding selecting unit 110 acquires, as the selected imaging finding, an imaging finding having a different value when the elements of the respective findings in the same abnormal shadow are compared to each other. At this time, the selected imaging finding may be narrowed down through use of the information on the influence degree acquired in Step S1405. Further, a finding having a change representing exacerbation, such as an increase in size of the abnormal shadow, may be preferentially acquired.

Processing steps subsequently performed from Step S1408 to Step S1410 are similar to the processing steps performed from Step S1007 to Step S1009 in the second embodiment.

As described above, in the image processing apparatus according to the present disclosure, as described with reference to the functional configuration in the third embodiment, the finding acquiring unit 104 (finding acquiring unit) may obtain a second imaging finding from the radiogram interpretation result storage unit 118. In this mode, the finding acquiring unit 104 functions as a finding acquiring unit in the present disclosure. At this time, the second imaging finding includes, for example, a corresponding radiogram interpretation result acquired in Step S1406 described above. The finding selecting unit 110 can select at least one imaging finding based on the first imaging finding group and this second imaging finding. Further, as described above, the user may manually input the finding information, and, in this case, the finding acquiring unit 104 acquires a plurality of imaging findings by a method other than inference. As described above, the finding acquiring unit 104 is not limited to acquiring the imaging finding by inference described in, for example, the first embodiment, and can acquire the imaging finding by various publicly-known methods.

Through execution of the processing described above, the image processing condition suitable for checking the imaging finding that is required to be checked by the doctor, such as an imaging finding having a change in time series, can be automatically determined, and an image satisfying this image processing condition can be automatically displayed. In this manner, time and effort required for the user to perform image adjustment can be reduced.

### Modification Example 1 of Third Embodiment

The radiogram interpretation result acquired in Step S1406 described above in the third embodiment is a corresponding radiogram interpretation result that can be acquired from a server (not shown). However, the radiogram interpretation result to be acquired is not limited to a radiogram interpretation result acquired from a server, and may be a radiogram interpretation result created by the user himself or herself or by another user for the same target image. In this manner, for an imaging finding that is required to be checked by the doctor because there is a possibility that a wrong finding is acquired by the finding acquiring unit 104, display suitable for checking this imaging finding can be performed.

### Modification Example

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The image processing apparatus according to each embodiment described above may be implemented by a sole apparatus or may adopt a mode in which the above-mentioned processing is executed by combining a plurality of apparatus to be communicable to each other. Any case is included in the embodiments of the present invention. A common server apparatus or a server farm may execute the above-mentioned processing. The plurality of apparatus forming the image processing apparatus and the image processing system are only required to be communicable to each other at a predetermined communication rate, and are not required to be present in the same facility or the same country.

Thus, a program code itself to be installed in a computer in order to execute the processing in the embodiments by the computer is also one embodiment of the present invention. Further, an OS or the like operating in the computer may perform part or the whole of the actual processing based on an instruction included in a program read out by the computer, and the functions of the embodiments described above may be implemented even by this processing. Further, a mode in which the above-mentioned embodiments are combined with each other as appropriate is also included in the embodiments of the present disclosure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-079923, filed May 15, 2023, which is hereby incorporated by reference herein in its entirety.

What is claimed is:

1. An image processing apparatus comprising:
a finding acquiring unit configured to acquire, for a medical image being a diagnosis target, a plurality of imaging findings as a first imaging finding group;
a finding selecting unit configured to select at least one imaging finding from the plurality of imaging findings;
a determining unit configured to determine, for the selected at least one imaging finding, an image processing condition suitable for observation of an imaging finding; and
an image acquiring unit configured to acquire a display image satisfying the determined image processing condition.

2. The image processing apparatus according to claim 1, wherein the finding acquiring unit is configured to acquire an imaging finding obtained through inference performed on the medical image.

3. The image processing apparatus according to claim 1, wherein the finding selecting unit is configured to select the at least one imaging finding based on a likelihood of an imaging finding inferred by the finding acquiring unit.

4. The image processing apparatus according to claim 3, wherein the finding acquiring unit is configured to convert an image feature amount of the medical image being the diagnosis target into the first imaging finding group having the likelihood assigned thereto.

5. The image processing apparatus according to claim 1, further comprising an influence degree acquiring unit configured to acquire an influence degree on diagnosis of an imaging finding inferred by the finding acquiring unit,
wherein the finding selecting unit is configured to select the at least one imaging finding based on the acquired influence degree.

6. The image processing apparatus according to claim 5, further comprising a diagnosis inference unit configured to infer a diagnosis name through use of an imaging finding as input,
wherein the influence degree acquiring unit is configured to acquire, as the influence degree on the diagnosis, an influence degree of the imaging finding on the inferred diagnosis name.

7. The image processing apparatus according to claim 1, further comprising a finding acquiring unit configured to acquire at least one second imaging finding corresponding to a medical image that corresponds to the medical image being the diagnosis target and has a different imaging period,
wherein the finding selecting unit is configured to select the at least one imaging finding based on the first imaging finding group and the at least one second imaging finding.

8. The image processing apparatus according to claim 1, wherein the finding selecting unit is configured to select the at least one imaging finding based on the first imaging finding group and a second imaging finding obtained based on a medical image corresponding to the medical image being the diagnosis target.

9. The image processing apparatus according to claim 1, further comprising an identification unit configured to identify an abnormal shadow from the medical image being the diagnosis target,
wherein the determining unit is configured to determine the image processing condition for an imaging finding relating to the abnormal shadow, and
wherein the image acquiring unit is configured to acquire an image satisfying the image processing condition and including the abnormal shadow as the display image.

10. The image processing apparatus according to claim 1, wherein the determining unit is configured to determine the image processing condition based on an item of the selected at least one imaging finding and a value of the selected at least one imaging finding.

11. The image processing apparatus according to claim 1, wherein the image acquiring unit is configured to acquire, as the display image, the medical image being the diagnosis target subjected to image processing that is based on the image processing condition determined by the determining unit.

12. The image processing apparatus according to claim 11, wherein the image processing that is based on the image processing condition is at least one of luminance level changing processing, gradation converting processing, resolution converting processing, or cropping processing.

13. The image processing apparatus according to claim 1, wherein the image acquiring unit is configured to acquire the display image based on the image processing condition from a plurality of images subjected to different types of image processing.

14. The image processing apparatus according to claim 1, further comprising a display control unit configured to cause a display unit to display the medical image being the diagnosis target.

15. The image processing apparatus according to claim 14, wherein the display control unit is configured to generate, when the medical image being the diagnosis target is displayed, a partial medical image including a region corresponding to the at least one imaging finding from the display image, and cause the display unit to display the partial medical image.

16. The image processing apparatus according to claim 15, wherein the display control unit is configured to cause, when the image processing condition applied to display of the medical image being the diagnosis target is different from the image processing condition of the partial medical image determined by the determining unit, the display unit to display a superimposition image obtained by superimposing the partial medical image onto the medical image being the diagnosis target.

17. The image processing apparatus according to claim 15, wherein the display control unit is configured to cause, when the image processing condition applied to display of the medical image being the diagnosis target is different from the image processing condition of the partial medical image determined by the determining unit, the display unit to display the partial medical image so as to be comparable to the medical image being the diagnosis target.

18. The image processing apparatus according to claim 1, further comprising a display control unit configured to cause, when the image processing condition applied to display of the medical image being the diagnosis target is different from the image processing condition determined by the determining unit, a display unit to display the display image so as to be comparable to the medical image being the diagnosis target.

19. The image processing apparatus according to claim 14, wherein the display control unit is configured to cause, when a plurality of imaging findings are selected and image processing conditions are determined for the plurality of imaging findings, respectively, the display unit to display, together with the medical image being the diagnosis target, display images satisfying the plurality of the image processing conditions, respectively, in a switchable manner.

20. An image processing method comprising:
acquiring, for a medical image being a diagnosis target, a plurality of imaging findings as a first imaging finding group;
selecting at least one imaging finding from the plurality of imaging findings;
determining, for the selected at least one imaging finding, an image processing condition suitable for observation of an imaging finding; and
acquiring a display image satisfying the determined image processing condition.

21. A recording medium for recording a program for executing each of the steps of the image processing method of claim 20 when being executed by a computer.
